(19) United States
(12) Patent Application Publication
(10) Pub. No.: US 2007/0005819 A1
(43) Pub. Date: Jan. 4, 2007

(54) Apparatus and method to guarantee unique connection tags across resets in a connection protocol

(76) Inventors: Jeffrey D. Skirvin, Mesa, AZ (US); Nathan Marushak, Gilbert, AZ (US); Roger C. Jeppsen, Chandler, AZ (US); Jonathan G. Wootten, Queen Creek, AZ (US); Richard G. Boyd, Gilbert, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/170,855

(22) Filed: Jun. 30, 2005

(51) Int. Cl. G06F 3/00

(52) U.S. Cl. 710/8

(57) ABSTRACT

A method and apparatus to guarantee unique connection tags across resets in a connection protocol. In one embodiment, the methods include the update of a reset counter following a system reset. In one embodiment, once updated, a controller, such as, for example, an input/output (I/O) controller, may receive a response from a target device to an I/O request that was issued to the target device prior to system reset. In one embodiment, the I/O controller may determine a reset counter value associated with the received response. If the received response includes a reset counter value that does not match a local reset counter held by the I/O controller, the I/O controller may disregard the received response. Other embodiments are described and claimed.

### FIELD

One or more embodiments relate generally to the field of integrated circuit and computer/system design. More particularly, one or more of the embodiments relate to a method and apparatus to guarantee unique connection tags across resets in a connection protocol.

### BACKGROUND

In today's host bus adapters and related controllers, proper handling of board resets (soft and hard) presents a difficult problem. In general, firmware running on the board being reset has to assume a catastrophic error. Specifically, the firmware has to operate with a mindset that the board is being reset, because there is a gross problem. This problem could be something with the firmware, itself. Therefore, the firmware may be architected to assume there is something wrong with itself, in response to a board reset.

Hence, the design of conventional storage controller firmware prevents termination of outstanding input/output (I/O) requests because the firmware is not capable of successfully sending a request to terminate. In other words, it is possible that firmware can be reset. Following reset of the firmware, the firmware may initiate discovery of devices and then begin receiving frames for an I/O request that was issued prior to the board reset. Unfortunately, the firmware does not know that the frames being received are for an I/O request issued prior to the reset. As a result, catastrophic, and often hard to diagnose, problems (e.g., data corruption or a hung system) may result from receipt of frames issued in response to an I/O request issued before system reset.

For example, assuming an I/O request from a host driver was issued by an I/O controller to a target device prior to system reset. Following system reset, the host driver may once again issue an I/O request to the target device. Upon receipt of the I/O request following system reset, an I/O controller may receive a response to the I/O request issued prior to the system reset. In this situation, data corruption can occur because the host driver, and the I/O controller no longer expect to receive a response to the previous request, but do expect a response to the current request. Since the current request may be for a different logical address than the previous request, it is possible that incorrect data is supplied to the host driver.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating a computer system including response verification logic to guarantee unique connection tags across resets in a connection protocol, in accordance with one embodiment.

FIG. 2 is a block diagram further illustrating the response verification logic of FIG. 1, in accordance with one embodiment.

FIG. 3 is a block diagram illustrating an open address frame with an embedded initiator connection tag, in accordance with one embodiment.

FIG. 4 is a block diagram further illustrating the initiator connection tag of FIG. 3, in accordance with one embodiment.

FIG. 5 is a flow diagram illustrating a method for ensuring unique connection tags across resets in a connection protocol, in accordance with one embodiment.

FIG. 6 is a flow diagram illustrating a method for a reset initialization sequence to reset a connection tag, in accordance with one embodiment.

FIG. 7 is a block diagram illustrating various design representations or formats for simulation, emulation and fabrication of a design using the disclosed techniques.

### DETAILED DESCRIPTION

A method and apparatus to guarantee unique connection tags across resets in a connection protocol. In one embodiment, the methods include the update of a reset counter following a system reset. In one embodiment, once updated, a controller, such as, for example, an input/output (I/O) controller, may receive a response from a target device to an I/O request that was issued to the target device prior to system reset. In one embodiment, the I/O controller may determine a reset counter value associated with the received response. If the received response includes a reset counter value that does not match a local reset counter held by the I/O controller, the I/O controller may disregard the received response.

System

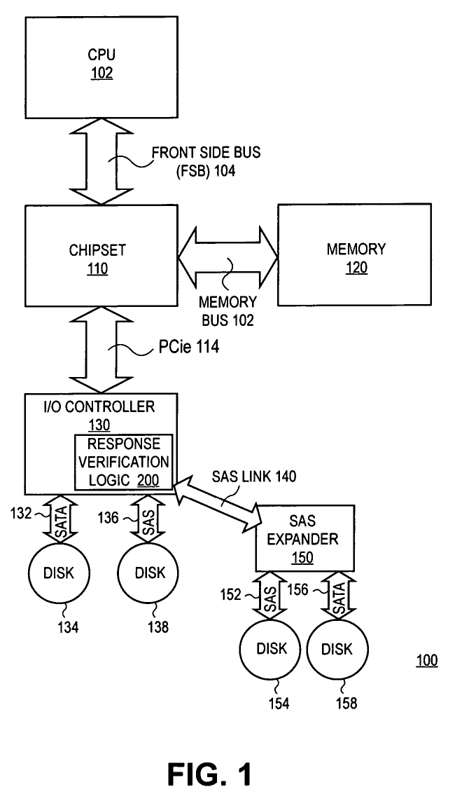

FIG. 1 is a block diagram illustrating a computer system 100 including response verification logic 200 to ensure the unique connection tags across resets in a connection protocol, in accordance with one embodiment. Representatively, computer system 100 may comprise a processor system bus (front side bus (FSB)) 104 for communicating information between processor (CPU) 102 and chipset 110. As described herein, the term “chipset” is used in a manner to collectively describe the various devices coupled to CPU 102 to perform desired system functionality.

Representatively, chipset 110 is coupled to main memory 120 via memory bus 112. In one embodiment, chipset 110 may include a memory controller (not shown) for issuing requests and receiving data from memory 120 for CPU 102 and input/output (I/O) controller 130. In one embodiment, main memory 140 may include, but is not limited to, random access memory (RAM), dynamic RAM (DRAM), static RAM (SRAM), synchronous DRAM (SDRAM), double data rate (DDR), SDRAM (DDR-SDRAM), Rambus DRAM (RDRAM) or any device capable of supporting a high-speed temporary storage of data.

In one embodiment, CPU 102 may include an integrated memory controller (not shown) to provide a direct connection between CPU 102 and main memory 120. Chipset 110 may further include an I/O controller hub (ICH) (not shown). Representatively, chipset 110 is coupled to I/O controller 130 via interconnect 114. As shown, I/O controller 130 includes response verification logic 200 to enable I/O controller 130 to identify a response received from a target device (e.g., disk 134, 138, 154, 158) to an I/O request issued to the target device prior to a system reset. As described herein, the term “response” includes, but is not limited to, transmitted data, commands, connection requests or any other like frame type transmitted between an initiator and a target. As further described herein, a “connection frame” includes, but is not limited to, any frame type that is used by a point-to-point interconnect protocol including, but not limited to serial advance technology attachments (SATA), serial attached small computer system interface (SCSI) (SAS), or other like interconnect protocol.

Representatively, various target devices may be connected to I/O controller 130 via point-to-point interconnects, including, but not limited to, SATA, SAS interconnects or the like. Representatively, interconnect expander 150 is coupled to I/O controller 130 via interconnect link 140 to couple additional target devices (disk 154 and disk 158) to I/O controller 130.

In one embodiment, chipset 110 is coupled to I/O controller 130 via a peripheral component interconnect (PCI) Express (PCI-Ex) link 114. Representatively, PCI-EX link 114 may provide a point-point link, such as defined by PCI Express Base Specification 1.0a (Errata dated 7 Oct. 2003) to allow bi-directional communication between I/O controller 130 and chipset 110.

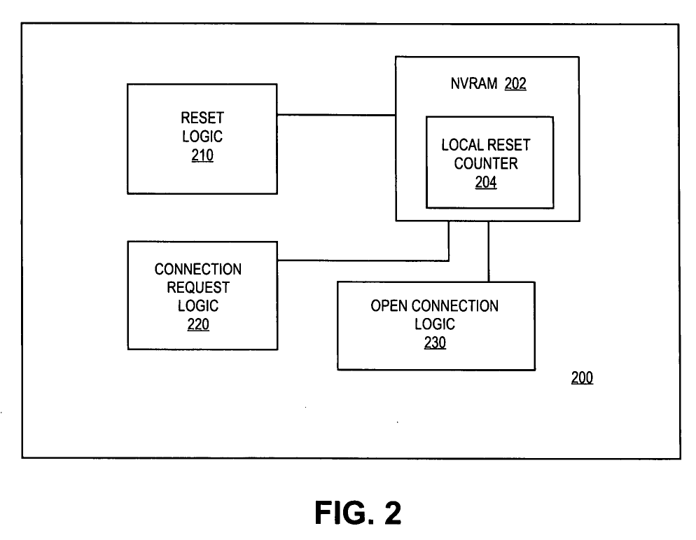

FIG. 2 is a block diagram further illustrating response verification logic 200 of FIG. 1, in accordance with one embodiment. As indicated above, response verification logic 200 enables I/O controller 130 to identify a response from a target device to an I/O request issued to the target device prior to a system reset. As described herein, in response to a system reset, I/O controller 130 may have outstanding I/O requests to multiple target devices (e.g., disks 134, 138, 154, 158). As indicated above, firmware of I/O controller 130 is architected to assume a catastrophic error has occurred in response to a system reset, possibly based on the firmware, itself.

As a result, I/O controller firmware 130 is unable to safely terminate outstanding I/O requests issued to target devices since its architecture prohibits the transmission of a request to terminate to the target device. Accordingly, in one embodiment, response verification logic 200 assumes that the firmware of I/O controller 130 is not capable of terminating outstanding I/O requests as part of a requested reset. Furthermore, target devices can have an arbitrarily long time before reconnecting to complete a request, such as, for example, delays caused by tape devices. Furthermore, the host/driver that initiated the I/O request is no longer interested in outstanding I/O requests subsequent to a system reset.

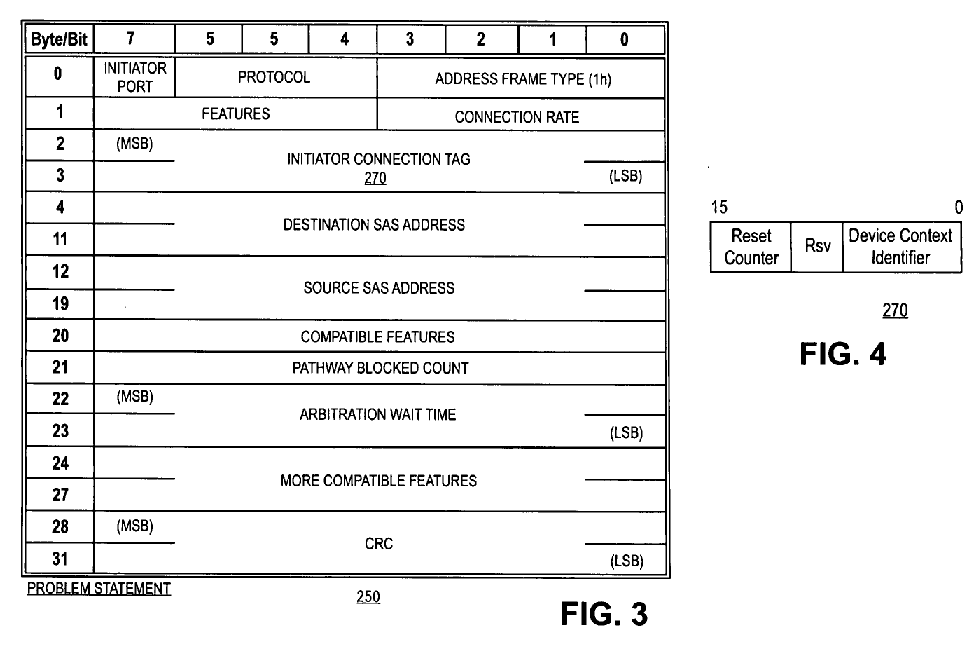

Referring again to FIG. 2, in one embodiment, response verification logic 200 is designed to insert a reset counter value (local reset counter) 204 within an initial connection frame issued to a target device. For example, in one embodiment, a target device may be coupled to the I/O controller via a SAS point-to-point interconnector. For example, as shown in FIG. 1, I/O controller 130 may be coupled to disk 138 via SAS interconnect 136. Accordingly, in one embodiment, open connection logic 230 inserts a value of local reset counter 204 into a SAS initiator connection tag field of an open address frame, for example, as shown in FIG. 3. As illustrated, reset logic 210, in one embodiment, increments local reset counter 204 each time a reset occurs.

In accordance with one embodiment, open connection logic 230, during an initiator mode, may insert a value of local reset counter 204 in each connection frame. In accordance with one embodiment, connection request logic 220, for each response received from a target device, requires extraction of a reset counter value embedded within, for example, initiator connection tag field 270 of the received response and comparison of the extracted reset counter value to local reset counter value 204. In one embodiment, reset logic 210 includes comparison logic (not shown) to determine whether the extracted reset counter value matches the local reset counter value. If a match is detected, connection request logic 220 is able to verify that the received response is to I/O request issued to the target device subsequent to a system reset.

In one embodiment, in response to detecting an extracted reset counter value which does not match local reset counter 204, connection request logic 220 may reject a received response from a target device, including the non-matching reset counter value. In one embodiment, connection request logic 220 may issue an open reject primitive to the target device. As shown local reset counter 204 is stored within non-volatile RAM 202 to accommodate hard resets without loss of local reset counter value 204.

FIG. 3 is a block diagram illustrating an open connection frame, which may be issued by I/O controller 130 or a target device (e.g., disk 134, 138, 154, 158). For example, in embodiments which use a SAS interconnect, SAS is a connection-oriented protocol. Accordingly, prior to transmitting data, commands, response or any other frame type, a connection must be established between an initiator and a target device. In one embodiment, the connection is accomplished by sending an open address (connection) frame 250 to a target. In response to receipt of an open connection frame, a target may send back an open accept primitive if the connection is accepted.

As shown in FIG. 4, in one embodiment, initiator connection tag 270 is modified to include a connection tag or reset counter 272. In one embodiment, response verification logic 200 dictates that initiator connection tag 270 can be set by initiators but must be adhered to by targets. Accordingly, in one embodiment, if a target receives connection frame 250 with initiator connection tag value in it, the target must use reset counter 272 from that connection tag 270 anytime it attempts to communicate with the particular initiator, as shown in FIG. 4.

Accordingly, by using the connection tag 270, I/O controller 130 (FIG. 1) may verify that the received response, connection frame, data frame, command frame or other like frame type is issued to an I/O request sent to the target device subsequent to system reset. In the embodiments described, if it is determined that the response is issued to an I/O request sent to the target device prior to system reset, the initiator may reject the connection frame by issuing, for example, an open reject primitive.

In the embodiments described, the size of the counter or location of the counter within a connection frame may be modified as desired by the implementation of the embodiments described herein, while remaining within the scope provided by the appended claims. In the embodiments described, open connection logic 230 is required to insert or embed reset counter 272, as shown in FIG. 4, within a predetermined area. In one embodiment, the connection tag, as shown in FIG. 4, is 16 bits. In accordance with such an embodiment, the reset counter is less than or equal to 16 bits. In a further embodiment, additional values may be placed into the connection tag field that identify the target context.

Although FIGS. 1 and 3 illustrate a SAS interconnect (136, 152) and SAS open address frame 250, it should be recognized that the embodiments described herein are not limited to SAS interconnections, but may include other like interconnect protocols, including, but not limited to, SATA interconnects, universal serial bus interconnects or other like point-to-point interconnects, collectively referred to herein as “connection protocols,” to provide and ensure a unique connection tag across resets in a connection protocol, in accordance with one embodiment. Procedural methods for implementing one or more embodiments are now described.

Operation

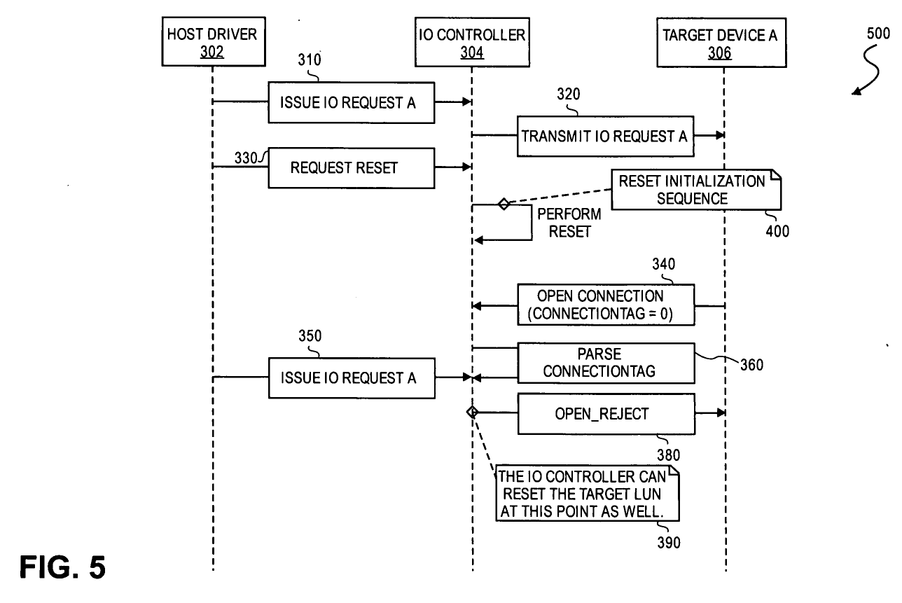

Turning now to FIG. 5, the particular methods associated with the embodiments of the invention are described in terms of computer software, firmware and/or hardware with reference to a flowchart. The methods to be performed by a computing device (e.g., an I/O controller) may constitute state machines or computer programs made up of computer-executable instructions. The computer-executable instructions may be written in a computer program and programming language or embodied in firmware logic. If written in a programming language conforming to a recognized standard, such instructions can be executed in a variety of hardware platforms and for interface to a variety of operating systems.

In addition, the embodiments of the invention are not described with reference to any particular programming language. It will be appreciated that a variety of programming languages may be used to implement embodiments of the invention, as described herein. Furthermore, it is common in the art to speak of software, in one form or another (e.g., program, procedure, process, application, etc.), as taking an action or causing a result, such expressions are merely a shorthand way of saying that execution of the software by a computing device causes the device to perform an action or produce a result.

FIG. 5 is a flowchart illustrating a method 300 to guarantee unique connection tags across resets in a connection protocol, in accordance with one embodiment. In the embodiments described, examples of the described embodiments will be made to reference to FIGS. 1-4. However, the described embodiments should not be limited to the examples provided. Accordingly, the following description, therefore, is not to be taken in a limiting sense, and the scope of various embodiments of the invention is defined only by the appended claims, along with the full range of equivalents to which such claims are entitled.

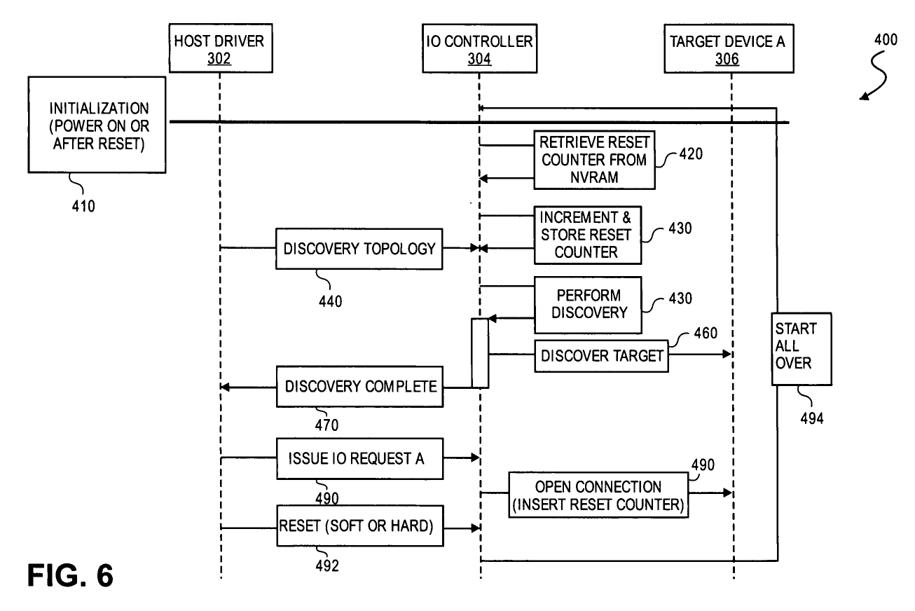

Referring again to FIG. 5, at process block 310, host driver 302 may issue an I/O request A to I/O controller 304. In the embodiment described, a local reset counter value is initially zero at the point in which I/O controller 304 receives the issued I/O request A from host driver 302. At process block 320, I/O controller 304 transmits an I/O request A to target device A 306. Subsequently, at process block 330, host driver 302 may request a reset. In response, I/O controller 304 as directed by, for example, reset logic 210 of response verification logic 200, as shown in FIG. 2, may perform a reset initialization sequence 400, as shown in FIG. 6.

Following reset initialization sequence 400, local reset counter 204 is incremented such that, for example, a value of local reset counter 204 is now equal to one. At process block 340, I/O controller 304 may receive a connection frame (open connection) having a connection tag equal to zero. In one embodiment, connection request logic 220 may parse or extract the connection tag from the received open connection frame at process block 350.

Representatively, local reset counter 204 is set to a value of one following increment of the local reset counter 204 during reset initialization sequence 400. Conversely, the connection tag extracted from the received connection frame is equal to zero. As a result, connection request logic 220 is able to identify that the open connection frame received at process block 340 is issued by the target device to an I/O request transmitted to target device A, prior to system reset, at process block 320.

Accordingly, in the embodiments described, following reset request 330, both I/O controller 304 and a host driver 302 are no longer interested in outstanding I/O requests issued prior to the reset request at process block 330. Therefore, at process block 380, connection request logic 220 may reject the connection request from target device 306 and issue, in one embodiment, an open reject primitive to terminate the previous I/O request to the target device 306.

As shown at process block 360, host driver 302 may once again issue an I/O request to target device 306. However, by having issued open reject primitive 380 to target device 306, following process block 390, the I/O controller 304 may reset a logical unit number (LUN) of target device 306 and subsequently issue or transmit I/O request A to target device 306 and terminate the previous I/O request.

FIG. 6 is a flowchart illustrating a method 400 for a reset initialization sequence, in accordance with one embodiment. Following reset, at process block 410, initialization begins subsequent to a power on self test (POST) or subsequent to reset. At process block 420, reset logic 210 of I/O controller may retrieve the reset counter from non-volatile memory.

At process block 430, the reset counter may be incremented and the new value stored within non-volatile memory. At process block 440, I/O controller 304 may initiate a discover topology request and at process block 450, may perform discovery to enumerate detected target devices. At process block 460, for example, I/O controller 304 discovers target device 306. Subsequently, at process block 470, discovery is complete. At process block 480, host driver 302 may once again issue an I/O request for target device 306. In response, I/O controller 304 may issue a connection frame at process block 490 to discovered target device 306. In one embodiment, open connection logic 230 inserts a reset counter value as a connection tag within, for example, an open address frame issued to target device 306. Subsequently, at process block 492, host driver 302 may issue a reset request for a soft or hard reset, at which point the process is repeated.

Accordingly, by embedding a reset counter into, for example, an initiator connection tag field, in one embodiment, an I/O controller or other like controller designed in accordance with the described embodiments may definitively determine the context for a given open connection. Defining the context of the given open connection enables the I/O controller to prevent hard to diagnose problems, such as data corruption and/or failure that arise after resets. As described, when a target device responds to an I/O request transmitted to the target device prior to a system reset and transmits a response to the I/O request subsequent to the system reset, by inspection of the connection tag value of the response, the response is identified as issued to an I/O request prior to system reset. Once identified, the previous request is terminated.

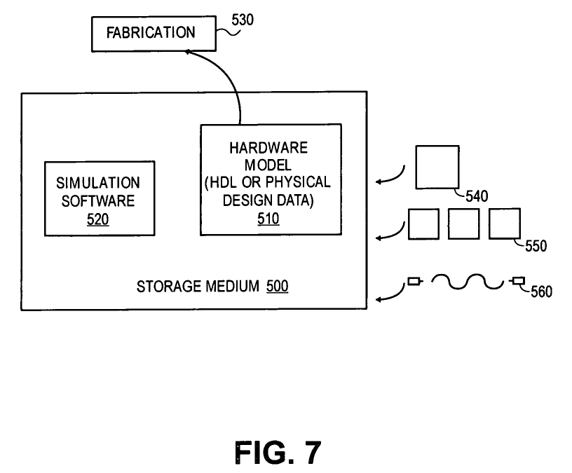

FIG. 7 is a block diagram illustrating various representations or formats for simulation, emulation and fabrication of a design using the disclosed techniques. Data representing a design may represent the design in a number of manners. First, as is useful in simulations, the hardware may be represented using a hardware description language, or another functional description language, which essentially provides a computerized model of how the designed hardware is expected to perform. The hardware model 510 may be stored in a storage medium 500, such as a computer memory, so that the model may be simulated using simulation software 520 that applies a particular test suite to the hardware model to determine if it indeed functions as intended. In some embodiments, the simulation software 520 is not recorded, captured or contained in the medium.

In any representation of the design, the data may be stored in any form of a machine readable medium. An optical or electrical wave 560 modulated or otherwise generated to transport such information, a memory 550 or a magnetic or optical storage 540, such as a disk, may be the machine readable medium. Any of these mediums may carry the design information. The term “carry” (e.g., a machine readable medium carrying information) thus covers information stored on a storage device or information encoded or modulated into or onto a carrier wave. The set of bits describing the design or a particular of the design are (when embodied in a machine readable medium, such as a carrier or storage medium) an article that may be sealed in and out of itself, or used by others for further design or fabrication.

### Alternate Embodiments

It will be appreciated that, for other embodiments, a different system configuration may be used. For example, while the system 100 includes a single CPU 102 for other embodiments, a multiprocessor system (where one or more processors may be similar in configuration and operation to the CPU 102 described above) may benefit from the response verification of various embodiments. Further different type of system or different type of computer system such as, for example, a server, a workstation, a desktop computer system, a gaming system, an embedded computer system, a blade server, etc., may be used for other embodiments.

Elements of embodiments of the present invention may also be provided as a machine-readable medium for storing the machine-executable instructions. The machine-readable medium may include, but is not limited to, flash memory, optical disks, compact disks-read only memory (CD-ROM), digital versatile/video disks (DVD) ROM, random access memory (RAM), erasable programmable read-only memory (EPROM), electrically erasable programmable read-only memory (EEPROM), magnetic or optical cards, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

In the above detailed description of various embodiments of the invention, reference is made to the accompanying drawings, which form a part hereof, and in which are shown by way of illustration, and not of limitation, specific embodiments in which the invention may be practiced. In the drawings, like numerals describe substantially similar components throughout the several views. The embodiments illustrated are described in sufficient detail to enable those skilled in to the art to practice the teachings disclosed herein. Other embodiments may be utilized and derived therefrom, such that structural and logical substitutions and changes may be made without departing from the scope of this disclosure. The following detailed description, therefore, is not to be taken in a limiting sense, and the scope of various embodiments of the invention is defined only by the appended claims, along with the full range of equivalents to which such claims are entitled.

Having disclosed embodiments and the best mode, modifications and variations may be made to the disclosed embodiments while remaining within the scope of the embodiments as defined by the following claims.

What is claimed is:

1. A method comprising:
updating a local reset counter following system reset;
identifying a response from a target device to an input/output (I/O) request issued to the target device prior to system reset if a value of the local reset counter does not match a reset counter value of the response; and
rejecting the identified response.

2. The method of claim 1, further comprising:
accessing the local reset counter from non-volatile memory following a power on self test (POST);
incrementing and storing the local reset counter within the non-volatile memory; and
performing discovery to discover at least one target device.

3. The method of claim 1, wherein prior to updating the local reset, the method further comprises:
receiving an I/O request for a target device;
transmitting the I/O request to the target device, including a value of the local reset counter; and
receiving a reset request.

4. The method of claim 2, further comprising:
issuing a connection frame to the discovered target device, including a value of the local reset counter embedded within an initiator connection tag of the connection frame.

5. The method of claim 1, wherein identifying the response further comprises:
receiving a connection frame from the target device;
comparing a connection tag value extracted from the connection frame within a value of the local reset counter; and
issuing a reject connection primitive to the target device if the connection tag value does not match the local reset counter value.

6. An article of manufacture comprising a machine-accessible medium having associated data, wherein the data, when accessed, results in a machine performing:
extracting a connection tag value from a connection frame received from a target device;
comparing the connection tag value to a local reset counter value;
identifying the received connection frame as issued in response to an input/output (I/O) request issued to the target device prior to a system reset if the connection tag value does not match the local reset counter value; and
issuing a reject connection primitive to the target device.

7. The article of manufacture of claim 6, wherein prior to receiving the open connection frame further results in the machine performing:
accessing the local reset counter from non-volatile memory following a power on self test (POST);
incrementing and storing the local reset counter within the non-volatile memory; and
performing discovery to discover at least one target device.

8. The article of manufacture of claim 7, wherein the machine-accessible medium further includes data, which when accessed by the machine further results in the machine performing:
issuing a connection frame to the discovered target device, including a value of the local reset counter embedded within an initiator connection tag of the connection frame.

9. The article of manufacture of claim 6, wherein the machine-accessible medium further includes data, which when accessed by the machine, further results in the machine performing:
resetting a logical unit number of the target device.

10. The article of manufacture of claim 6, wherein a value of the reset counter is embedded within an initiator connection tag field of an open address frame issued to a discovered target device.

11. An apparatus comprising:
a non-volatile memory to store a local reset counter; and
a controller, comprising response verification logic, including
reset logic to update the local reset counter within the non-volatile memory following a system reset, and
connection request logic to identify a response from a target device to an input/output (I/O) request issued to the target device prior to the system reset if a value of the reset counter does not match a local reset counter value extracted from the response.

12. The apparatus of claim 11, wherein the controller further comprises:
open connection logic to issue an open connection frame to a discovered target device, including a value of the local reset counter embedded within the open connection frame.

13. The apparatus of claim 11, wherein the reset logic is further to:
access the local reset counter from the non-volatile memory following a power on self test (POST), to increment and store the local reset counter within the non-volatile memory and to perform discovery to discover at least one target device.

14. The apparatus of claim 11, wherein the reset logic is further to:
update a logical unit number of the target device.

15. The apparatus of claim 11, wherein the response verification logic is further to:
issue a reject connection primitive to the target device.

16. A system comprising:
a processor;
a chipset coupled to the processor;
at least one target device; and
an input/output (I/O) controller coupled to the chipset, comprising a non-volatile memory and response verification logic, including:
reset logic to update a local reset counter stored within the non-volatile memory following a system reset, and
connection request logic to identify a response from the target device to an I/O request issued to the target device prior to the system reset if a value of the local reset counter does not match a connection tag value extracted from the response.

17. The system of claim 16, wherein the target device comprises:
open connection logic to extract a reset counter value from an initiator connection tag of an open connection frame received from the I/O controller and to embed the reset counter value within each frame issued to the I/O controller.

18. The system of claim 16, wherein the reset logic is further to:
access the local reset counter from the non-volatile memory following a power on self test (POST), to increment and store the local reset counter within the non-volatile memory and to discovery to discover at least one target device.

19. The system of claim 16, wherein the controller further comprises:
open connection logic to issue an open connection frame to a discovered target device, including a value of the local reset counter embedded within the open connection frame.

20. The system of claim 16, wherein the target device comprises a disk drive.
